(19) United States
(12) Patent Application Publication
(10) Pub. No.: US 2010/0134876 A1
(43) Pub. Date: Jun. 3, 2010

(54) WIRELESS SIGNAL PROXIMITY ENHANCER

(76) Inventor: Michael Fiddy, Huntersville, NC (US)

Correspondence Address: The University of North Carolina at Charlotte, Office of Technology Transfer - 269 Grigg Hall, 9201 University City Blvd., Charlotte, NC, 28223-0001, US

(21) Appl. No.: 12/499,834

(22) Filed: Jul. 9, 2009

Related U.S. Application Data
(60) Provisional application No. 61/079,523, filed on Jul. 10, 2008.

(51) Int. Cl. H01S 3/16

(52) U.S. Cl. 359/342

(57) ABSTRACT

A strongly anisotropic photonic crystal structure was designed using form birefringence. It has a low group velocity close to a split band edge (SBE) and large field enhancements proportional to the fourth power of the number of periods are predicted. The structure is used to amplify wireless signals outside and near the structure.

### RELATED APPLICATION DATA

The present application claims priority pursuant to 35 U.S.C. §119(e) to U.S. Provisional Patent Application Ser. No. 61/079,523, filed Jul. 10, 2008, which is incorporated herein by reference in its entirety.

### GOVERNMENT RIGHTS

This invention was made with government support under the Army Research Office, Grant No. W911NF-05-2-0053. The government has certain rights in this invention.

### BACKGROUND

1D anisotropic photonic crystal structures have attracted more attention in recent years due to their unusual and still somewhat surprising optical properties. Compared with 1D isotropic photonic crystal structures, the theoretical analysis, fabrication and characterization of 1D anisotropic photonic structures are less straightforward. Possible applications include slow-light devices and sensing [3-5]. Using band-edge resonances to slow down light in isotropic one-dimensional photonic crystal structure has been investigated by Scalora et al. [6]. It is well known that the maximum group delay and the associated field intensity enhancement occur at the transmission peak closest to the band-edge of the forbidden gap. Band edge resonant effects for anisotropic one-dimensional photonic crystal structures have been investigated by Mandatori et al [7] who specifically considered birefringence in 1D periodic band gap structures and Figotin and Vitebskiy [1,2]. The latter proposed that in the case of a transmission resonance in the vicinity of the degenerate band edge (DBE), which has degeneracy of the order 4, the resonant field intensity enhancement is proportional to N⁴, where N is the total number of periods rather than regular band edge (RBE) whose field intensity enhancement is proportional to N².

### BRIEF SUMMARY OF THE INVENTION

The following is intended to be a brief summary of the invention and is not intended to limit the scope of the invention.

A periodic structure which enhances the reception of wireless signals which has multiple periods, each period has multiple layers consisting essentially of anisotropic layers and isotropic layers.

The periodic structure of paragraph 5 wherein the layers have an orientation angle between them of 10 to 45 degrees.

The periodic structure of paragraphs 5 and 6 wherein the orientation angle is optimized using methods known in the art to increase signal strength.

The periodic structure of paragraph 5 wherein at least one layer is a spacer layer.

The periodic structure of paragraph 5 wherein there are at least 10 periods.

The periodic structure of paragraph 5 wherein the period has three layers consisting of two anisotropic layers and 1 isotropic layer.

The periodic structure of paragraph 5 wherein the cross-section is smaller then the height of the structure.

The periodic structure of paragraph 5 wherein at least one layer is form birefringent material.

The periodic structure of paragraph 5 wherein at least one layer consists of material known in the art to be conducting.

A method of amplifying wireless signals using the periodic structure of paragraph 5.

A method of amplifying wireless signals wherein the structure of paragraph 5 is placed on or near a cell phone.

A method of amplifying wireless signals wherein the structure of paragraph 5 is placed on or near a cell phone charger.

A method of amplifying wireless signals wherein the structure of paragraph 5 is placed on or near a computer, laptop, or electronic device that utilizes wireless signals to communicate voice or data.

### BRIEF DESCRIPTION OF THE DRAWINGS

FIG. 1. FIG. 1 shows one example of the physical structure of the present invention.

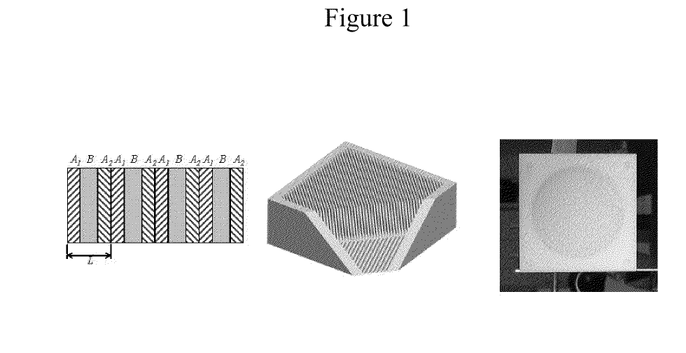

### DETAILED DESCRIPTION AND BEST MODE OF IMPLEMENTATION

In one embodiment, the present invention includes a periodic structure for which each period has multiple layers, for example a structure with three layers was built. There are two anisotropic layers which have an orientation angle between them and an isotropic layer. At least 10 periods in the structure are likely to be needed to see the effects proposed. In the working example, the anisotropic layers used birefringent materials (or form birefringent materials) with a degree of birefringence that is as large as possible and greater than 0.1. The period is of the order of the wavelength of interest or smaller and the effects described are general to electromagnetic waves.

In one aspect, the invention uses a thin structure in which the field enhancement that occurs that can be placed on or close to a wireless device to increase the field it receives. For example it could be placed on the back of a call phone or a laptop or placed in close proximity to one. To make the device thinner, the permittivity of the layers in the structure is increased. This is achieved this by making the layers slightly conducting in order to increase permittivity faster than one increases the corresponding loss factor. It should be noted that enhancement can be optimized as a function of orientation angle for a given number of periods; hence we can optimize the thickness of the compressed stack to achieve a given enhancement for a given application or need. It should further be noted that the device cross-section is an important parameter that affects internal and external enhancement factors. We propose a single (spatial) mode structure that remains periodic and enhances the internal and external field through the same mechanism. For the materials we are currently using in the working example, (form birefringent structure based on the polymer ABS) we would require a structure with a radius of 1.2 cm or smaller. If operating in single mode and using a smaller radius then one would have most of the enhanced field outside the structure, further improving the proximity enhancement effect.

The present invention enhances fields inside and outside the structure; the external fields decay slowly and can exhibit regions of unusually high intensity.

In the working example, the material used is a low loss dielectric at microwave frequencies and goes under the name ABS . . . . Poly (Acrylonitrile, Butadiene, Styrene). We have also used something similar but which has the trade name Fullcure. It is one aspect of the invention to increase their permittivity or make structures differently containing some metallic elements, to reduce the overall size of the structure.

In a further aspect, the present invention uses a 1D strongly anisotropic photonic crystal structure which was designed to have large resonant effects in transmission and reflection and a very low group velocity close to a degenerate band edge (DBE). In a working example of the invention form birefringence is employed to realize the high degree of anisotropy required for a DBE as suggested by the theoretical work of Figotin and Vitebsky [1,2]. Anisotropies greater than 10% are needed and this is very hard to achieve with naturally occurring materials at optical frequencies. In addition, each period of the structure requires two anisotropic and one isotropic layer and the degree of anisotropy and layer thicknesses allow one to tune the resonance conditions. In principle, at a transmission resonance in the vicinity of a DBE, the resonant field intensity increases as N⁴ within the structure where N is the total number of periods. In the case of a regular band edge, the field intensity is only proportional to N². Numerical results are presented illustrating the bandgap behavior as a function of anisotropy and both microwave and optical structures have been made. The optical structure is a challenge because of the form birefringent feature sizes that have to be fabricated. The microwave structure has exhibited the level of field enhancements predicted (˜X80 for the material properties we used) and unexpected field enhancements at specific frequencies and locations outside the structure were also observed. A closer look at these resonance effects have shown a strong correlation between the frequency at which the internal field enhancement occurs and a distinct and highly reproducible positive slope in the transmission phase spectrum. An interpretation of this is a change in sign of the group delay or effective negative refractive index.

In a further aspect, the present invention uses multiple layer structure including anisotropic media, which is nonmagnetic and not optically active and the Cartesian coordinate system is chosen such that the x axis is normal to the interface. From Snell's law, when a single plane wave propagates through the multiple layer structure, the tangential components of the wave vectors remain the same throughout the layered medium, and all the wave vectors lie in the same plane (the incident plane). Without loss of generality, the light propagation can be assumed to be in the x-y plane, as a consequence, the z-component of the wave vector is zero, the electric field has an exp i(k₀αx+k₀βy−ωt) dependence in each layer, where, k₀=2π/λ=ω/c, α=n cos θ and β=n sin θ. A plane wave propagating in the x-y plane and incident on a single parallel-sided layer of biaxial material, as illustrated in Fig. A will initiate four plane waves in the biaxial layer, two forward-traveling waves and two backward-traveling waves in the same x-y plane. The four waves are linearly polarized, and share the same value of the Snell's law quantity β with the incident wave. Representing the electromagnetic field in the form of the plane harmonic waves \vec{E}=\vec{E}₀e^{i(\vec{k}\vec{r}-ωt)} and \vec{H}=\vec{H}₀e^{i(\vec{k}\vec{r}-ωt)}, one can obtain Maxwell's equations in the matrix form

where matrix nŝ implements the (\vec{k}/k₀)×operation, which can be represented by equation (2)

$$n \hat{ s} = [ \begin{matrix}0 & 0 & β \\ 0 & 0 & - α \\ - β & α & 0\end{matrix} ] \qquad ( 2 )$$

Here \hat{∈} is the permittivity tensor, and z₀≡(μ₀/∈₀)^{1/2}.

The four traveling wave fields in a biaxial layer change phase linearly with displacement in the x-direction, but at different rates. Along the same path, which is assumed to be always in the same layer, the absolute values of the field coefficient α's remain constant but the phase changes. The phase matrix,

$${\hat{A}}_{d} = [ \begin{matrix}exp ( - {iφ}_{1}^{+} ) & 0 & 0 & 0 \\ 0 & exp ( - {iφ}_{1}^{-} ) & 0 & 0 \\ 0 & 0 & exp ( - {iφ}_{2}^{+} ) & 0 \\ 0 & 0 & 0 & exp ( - {iφ}_{2}^{-} )\end{matrix} ]$$

where φ_{1.2}^{±}=k₀α_{1.2}^{±} d transforms the traveling wave field coefficient from one point (at x=x₀, say) to the traveling wave field coefficients at another point (at x=x₀−d). The transformation property of Â_{d} can be written as \vec{a}ₓ_{₀}_{-d}=Â_{d}\vec{a}ₓ_{₀}, and thus this the phase matrix transforms the field coefficients between two points in the same layer. The propagation of the plane wave in a periodic medium obeys the Floquet theorem [1,2] by which we can get an equation for a unit cell

\hat{M}_{L}Ê_{K}(x)=exp(−iKL)\vec{E}_{K}(x)

The subscript K indicates that the function \vec{E}_{K}(x) depends on K which is known as the Bloch wave number. L denotes a period of the lattice with a defined cell and its field transfer matrix \hat{M}_{L}. Therefore the Bloch waves \vec{E}_{K}(x) are the eigenvectors of \hat{M}_{L} and Bloch wave numbers K are related to the eigenvalues of \hat{M}_{L}, Λᵢ by Λᵢ=exp(−iKᵢL). Because \hat{M}_{L} depends on ω and Snell's law quantity β, equation (4) can be considered as dispersion relation ω(K,β)=0. For birefringent media, \hat{M}_{L} is a 4×4 matrix, and one ω corresponds to four wave numbers Kᵢ. Real Kᵢ correspond to propagating Bloch waves and imaginary Kᵢ correspond to evanescent modes.

Based on the degeneracy of the Bloch wave numbers Kᵢ at a specific point ω=ω₀, one can find four types of special points in the dispersion curve. The first is an inflection point corresponding to a regular band edge point (RBE), which is the degenerate point of order 2 and one ω corresponds to two equal real K's. The second type is an inflection point called stationary inflection point (SIP), which has degeneracy of order 3 and one ω corresponds to three equal real K's. The third type is inflection point is called degenerate band edge point (DBE), which has fourth order degeneracy and one ω corresponds to four equal real K's. Finally one can realize a so-called split band-edge of SBE.

FIG. 2 illustrates the dispersion curves around these points. Since at the inflection points, the group velocities are all equal to 0, there is a strong field resonant effect connected with these points, but, because of their different degenerate orders, these resonant effects will differ from one to another.

Based on these predictions, we have investigated the band edge resonant field enhancement performance of anisotropic photonic crystal structures with various anisotropic materials [10]. The structure we studied has a unit cell with two misaligned in-plane anisotropic layers and one isotropic layer and simulations were based on the method described in ref [11]. By careful design of the parameters of the structure, one can design it to exhibit a degenerate band edge (DBE) around a central frequency of our choice. By making a comparison among different anisotropic materials, we have found that the giant resonant effects in the vicinity of the DBE need not only a relatively large degree of anisotropy (>10%) but also low absorption of the materials used. We have made a number of prototypes for use at microwave frequencies using a rapid-prototyping tool. They are simple and inexpensive to make. The feature sizes are of the order of a tenth of the wavelength. Of course, another advantage of exploiting form birefringence is that the final structure is porous and lends itself to possible sensing applications, as well as the insertion of probes or other optical elements.

Discrepancies between the measured data and those predicted by theory and simulation revealed some other properties of the physical structure. Measured and simulated data are shown below.

The data and the arrows above illustrate the discrepancy. Increasing the index contrast widens the bandgap but the measured indices of the form-birefringent layers are actually lower than predicted from the physical dimensions of the structure and the effective medium theory. For example, an index contrast of 1.2:1.35 has common TE and TM bandgap of width 0.6 GHz, while 1.2:1.5 has common bandgap of 1 GHz and 1.2:1.6 has a bandwidth of ˜1.3 GHz. By comparison, fixing the index contrast but reducing (increasing) the absolute index values shifts the bandgaps to higher (lower) frequencies but otherwise leaves the shape of the transmission spectrum the same. Thus constant contrast ratios produce the same bandgap and for example 1.2:1.35 has a band edge at 10 GHz, while 1.1:1.23 shifts the edge to 10.85 GHz.

The necessary condition for the existence of the DBE is that TE and TM modes should be coupled each other inside the structure so that 4×4 matrix has to be always involved to solve the dispersion relation. If TE and TM modes are decoupled, the field transfer matrix will be reduced to the block-diagonal form, the dispersion relation will exist for TE and TM modes separately, and there is no DBE point. Even if anisotropic layers are present, but the anisotropy axis in all anisotropic layers are either aligned, or perpendicular to each other, TE and TM modes are still decoupled. The only way to satisfy the DBE condition under the normal incidence is to have at least two misaligned anisotropic layers in a unit cell with the misalignment angle being different from 0 and π/2.

Design of the Split Band Edge Structure

Chabanov [12] recently presented experimental results showing a strongly resonant transmission associated with a split band edge phenomenon having near perfect impedance matching at the boundaries and polarization independence. Rotation of the angle f between the anisotropic layers guaranteed a resonance for a given number of periods, N, even when N is small. He shows the superiority of SBE over DBE as a resonator and over a defect localized state in the bandgap. By an SBE resonance, he refers to a resonance at the frequency at which the two counterpropagating slow (Bloch) modes, indicated below, can co-exist. Microwave experiments were conducted with two horns and teflon rods attached to a thin ring and spectra were obtained using an HP N5230A VNA. Figotin et al [13] since showed that the DBE point would not be perfectly impedance matched for any polarization state, it being the result of a coupling with only one elliptic polarization state of the incident field. This paper shows that the “giant enhancement” predicted with the DBE point can still be achieved with an SBE resonance by changing f. This has been our motivation for designing and fabricating a structure, with circular cross section form-birefringent layers that could be aligned and oriented with respect to each other, in order to exploit this SBE phenomenon. Our simulations indicate an SBE-like dispersion diagram as shown below, at which we might have a single frequency at the band edge for two counterpropagating k vectors, k+ and k−, but we might also have four k vectors close to this frequency, or two frequencies at Fabry Perot resonances which are closer in frequency near the band edge.

A simulation is shown alongside of the transmission spectra for a form-birefringent periodic structure designed to be close to the DBE-SBE split. It is interesting to observe the phase inflection close to the overlapping TE (blue) and TM (red) band edges. At these frequencies we can expect a negative group delay which can be interpreted as also corresponding to a negative effective index and which qualitatively resembles the measured phase spectrum shown in FIG. 3. Consequently one can expect the normal guiding properties of the structure to cease at these frequencies and the field emerge from the waveguide.

The first step in searching for an SBE or DBE point is to calculate the field transfer matrix for the unit cell. This depends on parameters such as the misalignment angle between two anisotropic layers φ, the dielectric permittivity and thickness of each layer, incident beam frequency ω, and incident direction θ (β=n sin θ, β=0 for the normal incident situation). After the field transfer matrix of the unit cell is known, using equation (8), one can calculate the dispersion curves in our specified frequency ranges. Adjusting the misalignment angle between two anisotropic layers, and the thickness of the isotropic layer D_{B}, one can find a possible parameter range for the SBE or DBE point by checking the corresponding dispersion curves. For the exact DBE point, we fix one parameter such as making φ equal to π/4, and adjust another parameter such as D_{B}, until the desired band edge is found. FIG. 5 shows the dispersion curve and an SBE behavior indicated by the red arrow.

The index of refraction of the bulk material used for the structure from which the data above were taken, is 1.64. The entire structure consisted of up to 55 periods or unit cells, with each unit cell made up of three layers A1, A2 and D as shown in FIG. 6. A1 and A2 are identical subwavelength 1-D grating layers having a φ=45 degree grating vector orientation with respect to each other, and the D layer in this case is simply air. The thickness of one unit cell L=1.23 cm, the thickness the anisotropic layer D_{A1}=D_{A2}=0.42 L=0.51 cm, and the thickness of the air layer D_{B}=0.18L=0.22 cm. The period of the form birefringent grating Λ=1 mm, which is about 1/30 of the incident wave wavelength, with a duty cycle 0.5. Effective medium calculations give nₒ=1.36, nₑ=1.21, which defines the dielectric tensor of the effective uniaxial thin film.

Fairly sharp Fabry-Perot resonances can be seen, as expected, despite the fact that we have only an approximation to an incident plane wave. Also, it is well known that disorder or defects in the photonic crystalline structure can have a significant effect on the transmission properties especially near a band edge. Mookherjea and Oh [14] argue that the strongest effects are at the band edge and conclude that, at least for the case of resonator coupling, variations in coupling coefficients of 1% to 10% can lead to reduced slow down factors (X10 to X30) because of band tail effects. Also, Freilikher et al [15], when modeling 1D “periodic-on-average” structures show that localized states (resonances) can occur in pass and stop bands.

Measurements of the associated field intensity enhancement were made. Large enhancements are seen up to factors of 80 a frequencies, as shown below in FIG. 7. The spatial position of the maximum field is observed near hole 15, the structure having small openings in each period for a probe, hole 1 being closest to the source.

That the peak enhancement occurs toward the input face of the structure is consistent with simulations in which the material properties exhibit some loss. Absorption losses can be seen to be quite significant but the measured enhancement we observed of 80 is consistent with the blue dashed curve in the lower left diagram. It is interesting to note that the initial rate of growth of the field is virtually independent of the number of periods, N. This is very encouraging since we can assume that an incident pulse experiences a significant slowdown factor corresponding to a large effective group index. It is this that can be exploited, where the field enhancement is at its largest, for sensing and superresolved imaging.

Significant and highly directional and frequency-specific fields were measured outside of the structure. The mechanisms responsible for this are likely to be due to the effective negative index at those frequencies. This may not be surprising since unusual scattering effects have been reported by others from aperiodic photonic structures [e.g. 16]. Also, as has been known for many years [e.g. 17], the effective refractive index can become less and unity, zero or negative leading to ultra refractive or diffractive effects near a bandgap. These all trace back to Notimi [18] who explains superprism effects and negative refraction and discusses high resolution 3D photography using negatively refracting photonic crystals.

In one embodiment, the present invention includes highly anisotropic 1D photonic crystal structure that was designed to exhibit maximum pulse delays and large field enhancements close to a degenerate band edge. The structure was designed by exploiting form birefringence. Initially it was done because there are no materials that could easily be used to realize this phenomenon at optical frequencies. Additional advantages however, for both optical and microwave applications are that the structures are low cost and easy to manufacture and they can be porous. The large field enhancements possible both inside and outside the structure are a function of the number of periods, N, and are predicted to increase as the fourth power of N. This dramatic effect lends itself to exploiting those enhanced fields for increased antenna sensitivity and increased sensor sensitivity where large intensities are required (see for example [20]). Because of the very large group index, objects inside or possibly inset on the surface of the structure, will be probed by much shorter wavelengths allowing higher resolution imaging or testing of those objects. One can also imagine the slow wave structure to be somewhat similar to a very high index immersion lens. Finally, our ability to tune the SBE to find a strong resonance provides an important degree of freedom not only to maximize the field enhancement internally but also it appears to control the emission frequency. We have observed that as a function of local structural changes and disorder, the transmission phase inflection can occur at multiple frequencies, some of which are associated with an effective negative index. This opens up the possibility of exploiting a structure such as this for phased array applications and local control of refractive index for imaging and sensing applications. Very preliminary data from external field measurements indicate some potentially powerful applications arising from the control of near and far field beam patterns around the structure. These could be actively exploited for communication purposes or for sensing once the full parameter set determining the control of these external properties are fully understood. Under certain conditions, reciprocity holds which further extends possible applications.

### REFERENCES

### Incorporated Herein by Reference

1. A. Figotin and 1. Vitebskiy, “Oblique frozen modes in periodic layered media,” Phys. Rev. B, 68, 036609 (2003).
2. A. Figotin and I. Vitebskiy, “Gigantic transmission band-edge resonance in periodic stacks of anisotropic layers”, Phys. Rev. E 72, 036619 (2005).
3. J. Ballato and A. Ballato, “Materials for freezing light”, Waves in Random and Complex Media, 15, 113-188, (2005)
4. A. Kanaev, Y. Cao, and M. A. Fiddy, “Axially frozen modes in finite anisotropic photonic crystals”, Opt. Eng., 44, (9), (2005).
5. Yang Cao, Michael A. Fiddy, “Resonant effect analysis at finite one-dimensional anisotropic photonic crystal band edges”, Proc. SPIE, 6128, 345-356 (2006).
6. M. Scalora, R. J. Flynn, S. B. Reinhardt, and R. L. Fork etc. “Ultrashort pulse propagation at the photonic band edge: large tunable group delay with minimal distortion and loss”, Phys. Rev. E 54, R1078-R1081 (1996).
7. A. Mandatori et al, “Birefringence in one-dimensional finite photonic bandgap structure”, J. Opt. Soc. Am. B, 20, p 504, (2003)
8. P. Yeh, “Electromagnetic propagation in birefringent layered media”, J. Opt. Soc. Am. 69, 742, (1972).
9. I. J. Hodgkinson and Q.-H. Wu, Birefringent Thin Films and Polarizing Elements, World Scientific, New Jersey, 1998.
10. A. Figotin and I. Vitebskiy, “Frozen light in photonic crystals with degenerate band edge”, Phys. Rev. E, 74, 066613 (2006)
11. Y. Cao, J. O. Schenk and M. A. Fiddy, “Third order nonlinear effect near a degenerate band edge” (submitted for publication).
12. A. Chabanov, “Strongly resonant transmission of electromagnetic radiation in periodic anisotropic layered media”, arXiv:0709.1250v1 [physics.optics] 9 Sep. 2007.
13. A. Figotin and I. Vitebskiy, “Slow wave resonance in periodic stacks of anisotropic layers,” Phys. Rev. A. 76, 053839 (2007).
14. S. Mookherjea and A. Oh, “Effect of disorder on slow light velocity in optical slow-wave structures”, Optics Letters, Vol. 32, p 289, (2007).
15. V. Freilikher et al, “Enhanced transmission due to disorder”, Phys Rev E vol. 51, p 6301, (1995).
16. L. Dal Negro et al, “Spectrally enhanced light emission from aperiodic photonic structures”, App. Phys. Lett., 86, 261905, (2005).
17. J. P. Dowling and C. M. Bowden, “Anomalous index of refraction in photonic bandgap materials”, J. Mod. Optics, 41 No. 2 p 345-351, (1994).
18. M. Notimi et al, “Theory of light propagation in strongly modulated photonic crystals: refractionlike behavior in the vicinity of the photonic band gap”, Phys. Rev. B, Vol 62, No 16, October 2000, p 10 696-10 705.
19. E. LeCoarer et al, “Wavelength-scale stationary wave integrated Fouirer transform spectroscopy”, Nature Photonics, Vol 1, p 473, (2007).
20. Figotin—November (Phys. Rev. A 76, 053839 (2007).

I claim:

1. A periodic structure which enhances the strength of wireless signals wherein the structure has multiple periods, each period has multiple layers consisting essentially of anisotropic layers and isotropic layers.
